(19) United States
(12) Patent Application Publication
(10) Pub. No.: US 2018/0017090 A1
(43) Pub. Date: Jan. 18, 2018

(54) DAMAGE TOLERANT PATTERNED BOND

(71) Applicant: Sikorsky Aircraft Corporation, Stratford, CT (US)

(72) Inventor: Jonathan K. Garhart, Seymour, CT (US)

(21) Appl. No.: 15/546,861

(22) PCT Filed: Feb. 5, 2016
(86) PCT No.: PCT/US16/16820

§ 371 Date: Jul. 27, 2017

Related U.S. Application Data
(60) Provisional application No. 62/114,282, filed on Feb. 10, 2015.

(51) Int. Cl. F16B 11/00; B29C 65/48; B29C 65/00; B29L 31/30

(52) U.S. Cl. CPC F16B 11/006; B29C 66/742; B29C 65/48; B29C 66/1122; B29L 2031/3076

(57) ABSTRACT

A bond is provided and includes a substrate having a first surface, a bond structure having a second surface and a bonding assembly adhesively disposed between complementary portions of the first and second surfaces. The bonding assembly includes discrete bond elements configured to form first and second adhesive zones with local sections of the complementary portions of the first and second surfaces. The discrete bond elements are displaced such that the respective first and second adhesive zones are correspondingly displaced and define discontinuous bond lines.

### BACKGROUND OF THE INVENTION

The subject matter disclosed herein relates to bonding and, more particularly, to damage tolerant patterned bonding of a bond structure to a substrate.

Bonding as means of joining primary airframe structures has been difficult to achieve due to concerns about failure mechanisms and detectability of flaws and defects associated with bond lines. That is, flaws or damage to bond lines tend to propagate under load leading to progressive failure and deficiency or degradation of a bond is considered to be a failure or potential failure of the entire bond and hence results in a lack of structural integrity. Redundant load paths or fasteners to supplement bonds are typically used to provide for joint confidence but also leads to a reduction in structural optimization and an increase in weight.

### BRIEF DESCRIPTION OF THE INVENTION

According to one aspect of the invention, a bond is provided and includes a substrate having a first surface, a bond structure having a second surface and a bonding assembly adhesively disposed between complementary portions of the first and second surfaces. The bonding assembly includes discrete bond elements configured to form first and second adhesive zones with local sections of the complementary portions of the first and second surfaces. The discrete bond elements are displaced such that the respective first and second adhesive zones are correspondingly displaced and define discontinuous bond lines.

In accordance with additional or alternative embodiments, the bond structure includes a section of a primary airframe structure.

In accordance with additional or alternative embodiments, intermediate material is disposed between the discrete bond elements.

In accordance with additional or alternative embodiments, the discrete bond elements include film adhesive.

In accordance with additional or alternative embodiments, the discrete bond elements have a tiled pattern structure made up of repeating polygonal forms, including, but not limited to triangles, rectangles and hexagons.

In accordance with additional or alternative embodiments, the discrete bond elements include a first group of discrete bond elements including high strength, high modulus adhesive material and a second group of discrete bond elements including high strain adhesive material.

In accordance with additional or alternative embodiments, the first and second groups are respectively disposed to form a compliance buffer zone in the bonding assembly.

According to another aspect of the invention, a method of bonding a bond structure to a substrate is provided and includes forming discrete bond elements for disposition on the substrate such that the discrete bond elements form first adhesive zones with local sections of the substrate and disposing the bond structure on the bonding assembly such that the discrete bond elements form second adhesive zones with local sections of the bond structure. The forming of the discrete bond elements includes displacing the discrete bond elements such that the respective first and second adhesive zones are correspondingly displaced and define discontinuous bond lines.

In accordance with additional or alternative embodiments, at least the bond structure includes metals, metallic alloys, composite materials and/or combinations thereof and is provided as a primary airframe structure.

In accordance with additional or alternative embodiments, the method further includes disposing intermediate material between the discrete bond elements.

In accordance with additional or alternative embodiments, the forming of the discrete bond elements includes casting film adhesive on a release ply and reducing the film adhesive to the discrete bond elements.

In accordance with additional or alternative embodiments, the reducing includes cutting material of the film adhesive from between the discrete bond elements.

In accordance with additional or alternative embodiments, the reducing includes forming the discrete bond elements to have a patterned polygonal structure.

In accordance with additional or alternative embodiments, the method further includes grouping a first group of discrete bond elements comprising high strength, high modulus adhesive material and grouping a second group of discrete bond elements comprising high strain adhesive material.

In accordance with additional or alternative embodiments, the method further includes respectively disposing the first and second groups to form a compliance buffer zone.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a bond in accordance with embodiments;

FIG. 2 is a top-down view of the bond of FIG. 1;

FIG. 3 is a top-down view of a bond in accordance with alternative embodiments;

FIG. 4 is a side view of adjacent discrete bond elements of the bond of FIGS. 1-3;

FIG. 5 is a perspective view of an initial stage of bond formation in accordance with embodiments;

FIG. 6 is a perspective view of an intermediate stage of bond formation in accordance with embodiments;

FIG. 7 is a perspective view of an intermediate stage of bond formation in accordance with embodiments; and

FIG. 8 is a perspective view of a late stage of bond formation in accordance with embodiments.

The detailed description explains embodiments of the invention, together with advantages and features, by way of example with reference to the drawings.

### DETAILED DESCRIPTION OF THE INVENTION

As will be described below, bond lines for aircraft airframe structures are proposed with adhesive zones that are discontinuous and cover a percentage of the overall surface. Failure of one or more of the adhesive zones in the designed pattern could be isolated once the fracture front reaches the extent of the local (i.e., discrete) bond element. A matrix of high strength, high modulus adhesive zones could also be separated by zones of higher strain adhesive to establish a compliance buffer to protect the leading edge of intact bonds from the stress discontinuity at the perimeter. Complex patterned adhesive film could be fabricated using modified prepregging equipment in a manner similar to modern high speed printing.

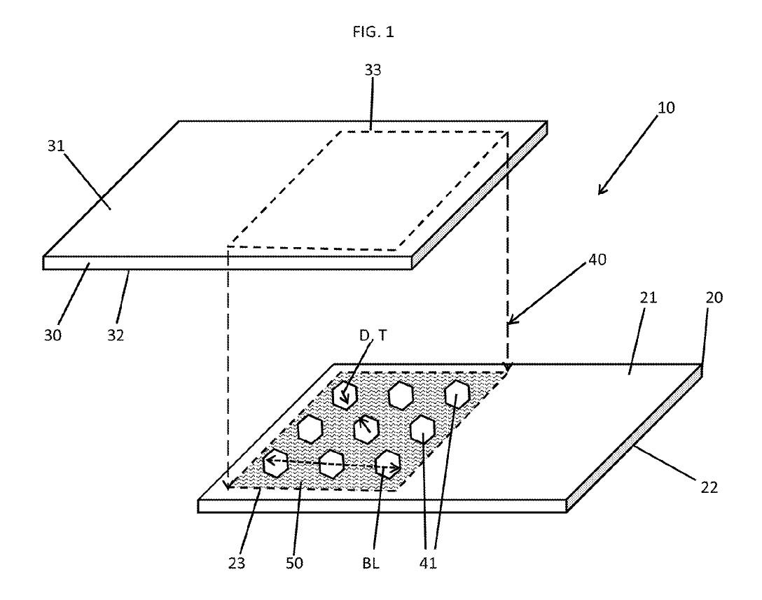

With reference to FIGS. 1-3, 7 and 8, a bond 10 is provided and includes a substrate 20, a bond structure 30 and a bonding assembly 40. The substrate 20 has first and second opposite surfaces 21, 22 that may be substantially planar or curved in one or more dimensions. The bond structure 30 similarly has first and second opposite surfaces 31, 32 that may be substantially planar or curved in one or more dimensions. Whether the substrate 20 and the bond structure 30 are planar or curved, the substrate 20 and the bond structure 30 have complementary portions 23, 33 that can be laid up on one another in an overlapping configuration such that the first surface 21 faces the second surface 32.

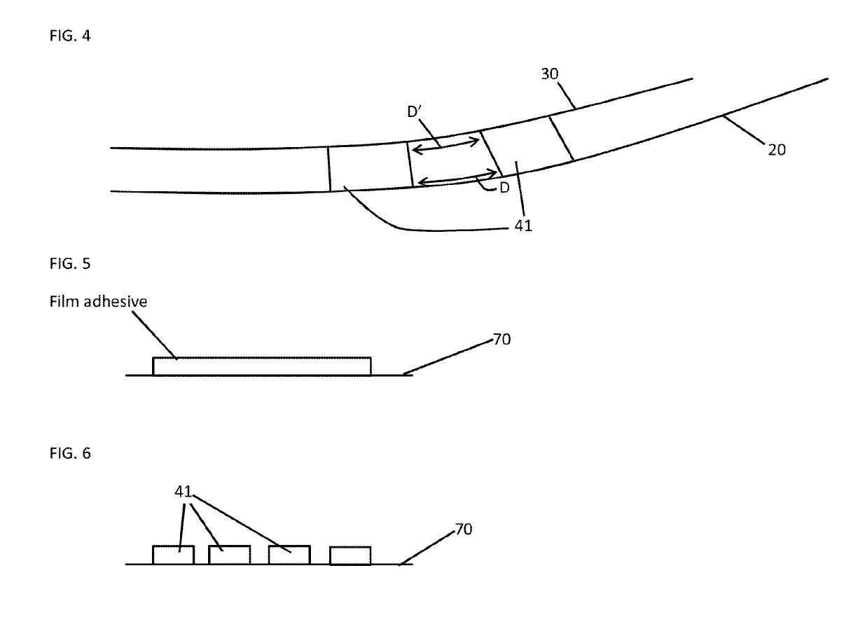

In accordance with embodiments, the substrate 20 may be formed of metals, metallic alloys, composite materials and/or combinations thereof. Similarly, the bond structure 30 may be formed of metals, metallic alloys, composite materials and/or combinations thereof and may be provided as a primary airframe structure of an aircraft. Thus, the planarity or curvature (see FIG. 4) of at least the bond structure 30 should be integrated with an overall structure of the primary airframe structure and may be aerodynamically integrated with an overall shape of the primary airframe structure.

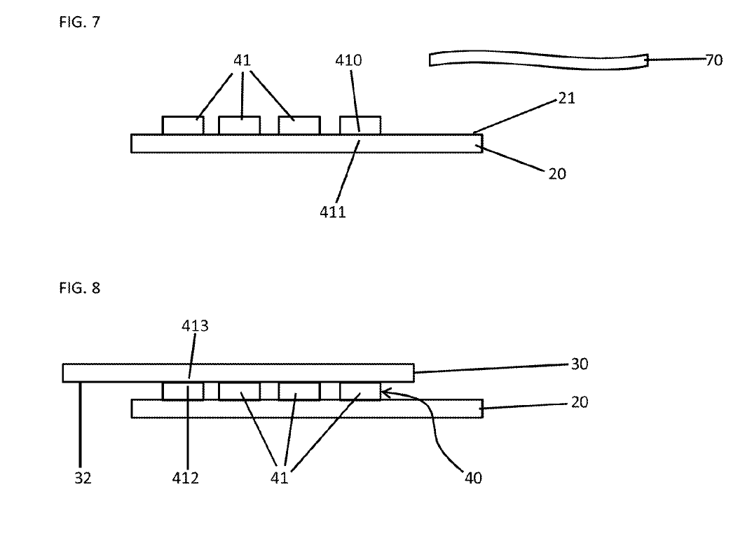

The bonding assembly 40 is adhesively disposed between the complementary portions 23, 33 of the first surface 21 and the second surface 32 and serves to adhere the bond structure 30 to the substrate 20. The bonding assembly 40 includes a plurality of discrete bond elements 41 that are each respectively configured to form a first adhesive zone 410 with a local section 411 of the complementary portion 23 of the first surface 21 (see FIGS. 1 and 7) and a second adhesive zone 412 with a local section 413 of the complementary portion 33 of the second surface 32 (see FIGS. 1 and 8). The discrete bond elements 41 are formed of film adhesive (e.g., epoxy or urethane) that may include compliant materials and are displaced from one another by at least distance D. As such, the respective first adhesive zones 410 are correspondingly displaced from one another and define discontinuous bond lines BL with respect to one another. Similarly, the discrete bond elements 41 are displaced from one another by at least the distance D such that the respective second adhesive zones 412 are correspondingly displaced from one another and define discontinuous bond lines BL with respect to one another.

In accordance with further embodiments, the bond 10 may include an intermediate material 50, such as a thermoplastic material or another similar type of material. Such intermediate material 50 may be disposed in the spaces defined between the discrete bond elements 41 to ensure separation of the discrete bond elements 41 and thus may have a thickness T, which may be substantially similar to the length of distance D.

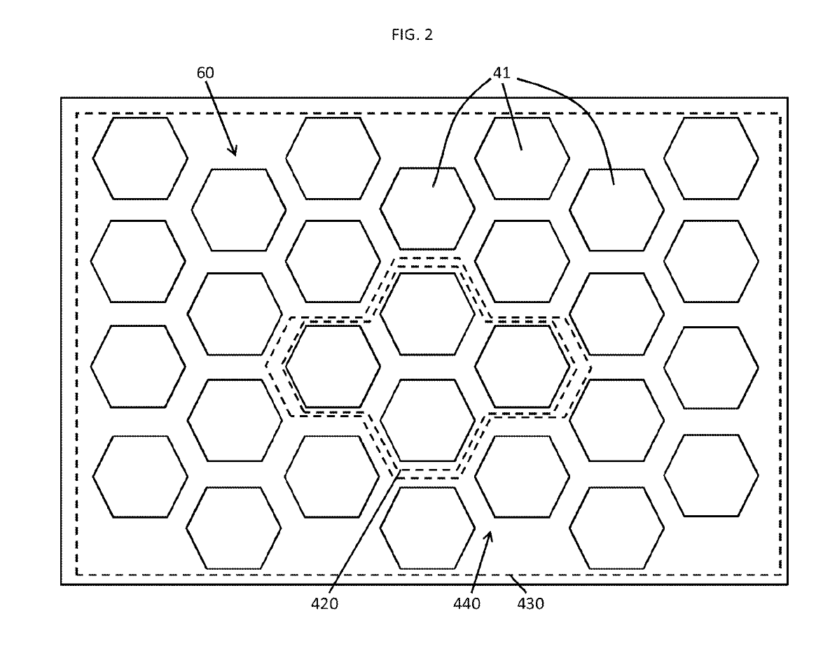

As shown in FIG. 2, the plurality of the discrete bond elements 41 may be disposed in a matrix with a patterned polygonal structure 60. This patterned polygonal structure 60 may be provided as a tiled pattern structure that is made up of repeating polygonal forms, including, but not limited to triangles, rectangles and hexagons. In accordance with embodiments, the patterned polygonal structure 60 may be provided such that each discrete bond element 41 has a substantially equilateral, regular hexagonal shape and is adjacent along its six edges to six other similarly shaped discrete bond elements 41. In this case, the discrete bond elements 41 are each displaced from those adjacent discrete bond elements 41 by a substantially constant distance D with any interposed intermediate material 50 having a substantially constant thickness T, which is substantially similar to the length of distance D.

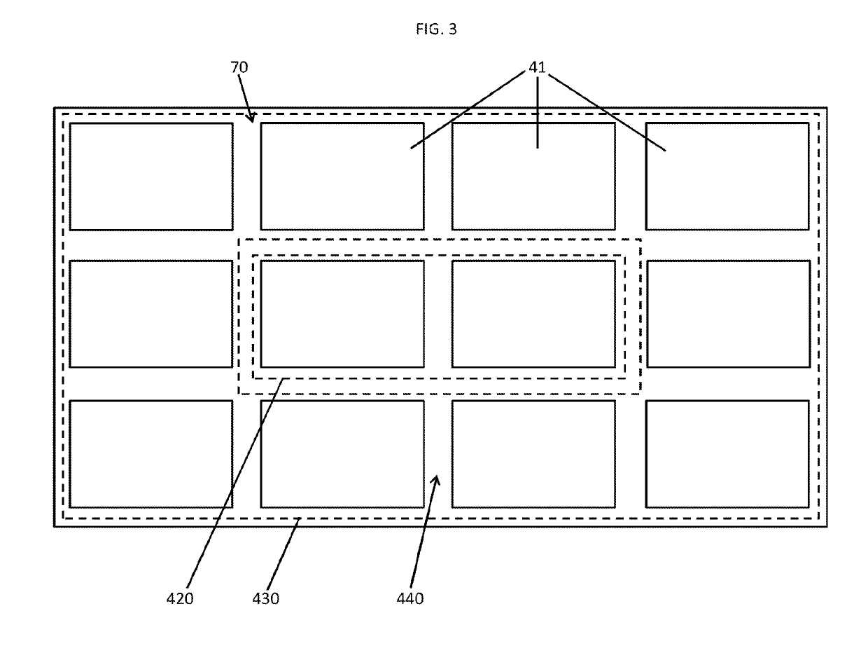

As shown in FIG. 3, the plurality of the discrete bond elements 41 may be disposed in a matrix with a polygonal structure 70 in which each discrete bond element 41 has a substantially equilateral, regular polygonal shape and is adjacent along its edges to other similarly shaped discrete bond elements 41. In this case, the discrete bond elements 41 are each displaced from those adjacent discrete bond elements 41 by a substantially constant distance D with any interposed intermediate material 50 having a substantially constant thickness T, which is substantially similar to the length of distance D.

Although the embodiments illustrated in FIGS. 2 and 3 illustrate that the plurality of the discrete bond elements 41 has a shape that mimics the individual shapes of the discrete bond elements 41 themselves and may, as shown in FIG. 3, mimic the overall shape of the substrate 20/bond structure 30, it is to be understood that these configurations are not necessary and that various embodiments are possible. For example, the patterned polygonal structure 60 of FIG. 2 could be associated with a rectangular substrate 20 and a similarly rectangular bond structure 30 whereas the polygonal structure 70 of FIG. 3 could be associated with a rounded substrate 20 and a similarly rounded bond structure 30. Also, even if the discrete bond elements 41 have a substantially equilateral, regular polygonal shape as shown in FIG. 3, the plurality of the discrete bond elements 41 could still be arranged in an alternative regular or irregular structure that is associated with an alternatively shaped substrate 20 and an alternatively shaped bond structure 30.

In any case, the plurality of discrete bond elements 41 may be provided in a first group 420 of discrete bond elements 41 and a second group 430 of discrete bond elements 41. In such a case, the discrete bond elements 41 of the first group 420 may include high strength, high modulus adhesive materials and the discrete bond elements 41 of the second group 430 may include high strain adhesive material. In accordance with embodiments, the respective matrices of the first and second groups 420, 430 may then be respectively disposed to form a compliance buffer zone 440 in the bonding assembly 40. Thus, as shown in FIGS. 2 and 3, the second group 430 surrounds the first group 420 in a plane of the bonding assembly 40 such that the compliance buffer zone 440 is provided at the outer periphery of the bonding assembly 40.

With the configurations described above, a failure of a given discrete bond element 41 may occur and manifest as a delamination along one of the first and second adhesive zones 410 and 412. In this case, the delamination may propagate under load until the delamination reaches the edge of the corresponding discrete bond element 41. At this point, even if the delamination continues to grow to encompass the entire one of the first and second adhesive zones 410 and 412, the delamination will not propagate to any one of the adjacent discrete bond elements 41.

In addition, with reference to FIG. 4, the distance D may be defined to permit a given curvature in the substrate 20 and the bond structure 30. That is, as shown in FIG. 4, the distance D may be defined at the substrate 20 such that the complementary edges of the adjacent discrete bond elements 41 proximate to the bond structure 30 are displaced from one another by a minimal threshold distance D′ for a given radius of curvature of the bond structure 30. In this manner, the respective second adhesive zones 412 for the adjacent discrete bond elements 41 remain displaced from one another and discontinuous. In accordance with embodiments, a difference between distance D and distance D′ may be minimal.

With reference to FIGS. 1 and 5-8, a method of bonding the bond structure 30 to the substrate 20 is provided. This method initially includes forming discrete bond elements 41 directly on the substrate 20 or on a release ply 70 (see FIGS. 5 and 6). The method then proceeds by disposition of the discrete bond elements 41 on the substrate 20 (if not already done so) such that the discrete bond elements 41 form the first adhesive zones 410 with the local sections 411 of the substrate 20 (see FIG. 7) at which point the release ply 70, if used, can be removed and discarded (see FIG. 7). Next, the intermediate material 50 may be interposed between the discrete bond elements 41 (see FIG. 1) and the bond structure 30 is disposed such that the discrete bond elements 41 form the second adhesive zones 412 with the local sections 413 of the bond structure 30 (see FIG. 8).

In accordance with embodiments, the interposition of the intermediate material 50 between the discrete bond elements 41 may be conducted during manufacture. In such cases, the resulting product would then be shipped as sheet stock to end users who could then complete assembly by forming the second adhesive zones 412 with the local sections 413 of the bond structure 30.

As described above and as shown in FIGS. 5 and 6, the forming of the discrete bond elements 41 may include displacing the discrete bond elements 41 away from one another such that the respective first adhesive zones 410 and second adhesive zones 412 are correspondingly displaced from one another and discontinuous. In accordance with embodiments, the forming may be accomplished by casting film adhesive to be formed into the discrete bond elements 41 on the release ply 70 and then reducing the film adhesive to the discrete bond elements 41 by cutting using a patterned tool formed to define the plurality of the discrete bond elements 41 as illustrated in FIGS. 2 and 3 in a single step or by cutting using a cookie-cutter tool to form each discrete bond element 41 individually.

In either case where the discrete bond elements 41 are formed in a single step or individually, it will be understood that the processing described herein could be conducted as part of a continuous process.

In accordance with further embodiments and as described above, the forming of the discrete bond elements 41 and the disposition of the discrete bond elements 41 of FIGS. 5-7 may be provided such that the plurality of the discrete bond elements 41 has a patterned polygonal structure and/or such that the discrete bond elements 41 are grouped into the first and second groups 420, 430. In addition, the forming of the discrete bond elements 41 and the disposition of the discrete bond elements 41 of FIGS. 5-7 may be provided such that the first and second groups 420, 430 form a compliance buffer zone 440.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A bond, comprising:
a substrate having a first surface;
a bond structure having a second surface;
a bonding assembly adhesively disposed between complementary portions of the first and second surfaces,
the bonding assembly comprising discrete bond elements configured to form first and second adhesive zones with local sections of the complementary portions of the first and second surfaces, and
the discrete bond elements being displaced such that the respective first and second adhesive zones are correspondingly displaced and define discontinuous bond lines.

2. The bond according to claim 1, wherein the bond structure comprises a section of a primary airframe structure.

3. The bond according to claim 1, further comprising an intermediate material disposed between the discrete bond elements.

4. The bond according to claim 1, wherein the discrete bond elements comprise film adhesive.

5. The bond according to claim 1, wherein the discrete bond elements have a patterned polygonal structure.

6. The bond according to claim 1, wherein the discrete bond elements comprise:
a first group of discrete bond elements comprising high strength, high modulus adhesive material; and
a second group of discrete bond elements comprising high strain adhesive material.

7. The bond according to claim 6, wherein the first and second groups are respectively disposed to form a compliance buffer zone in the bonding assembly.

8. A method of bonding a bond structure to a substrate, comprising:
forming discrete bond elements for disposition on the substrate such that the discrete bond elements form first adhesive zones with local sections of the substrate; and
disposing the bond structure on the bonding assembly such that the discrete bond elements form second adhesive zones with local sections of the bond structure,
the forming of the discrete bond elements comprising displacing the discrete bond elements such that the respective first and second adhesive zones are correspondingly displaced and define discontinuous bond lines.

9. The method according to claim 8, wherein at least the bond structure comprises metals, metallic alloys, composite materials and/or combinations thereof and is provided as a primary airframe structure.

10. The method according to claim 8, further comprising disposing intermediate material between the discrete bond elements.

11. The method according to claim 8, wherein the forming of the discrete bond elements comprises:
casting film adhesive on a release ply; and
reducing the film adhesive to the discrete bond elements.

12. The method according to claim 11, wherein the reducing comprises cutting material of the film adhesive from between the discrete bond elements.

13. The method according to claim 11, wherein the reducing comprises forming the discrete bond elements to have a patterned polygonal structure.

14. The method according to claim 9, further comprising:
grouping a first group of discrete bond elements comprising high strength, high modulus adhesive material; and
grouping a second group of discrete bond elements comprising high strain adhesive material.

15. The method according to claim 14, further comprising respectively disposing the first and second groups to form a compliance buffer zone.
